(19) United States
(12) Patent Application Publication
(10) Pub. No.: US 2008/0088968 A1
(43) Pub. Date: Apr. 17, 2008

(54) Storage medium drive

(75) Inventor: Yukihiro Komura, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/999,625

(22) Filed: Dec. 6, 2007

Related U.S. Application Data
(63) Continuation of application No. PCT/JP2005/010513, filed on Jun. 8, 2005.

(51) Int. Cl. G11B 5/012

(52) U.S. Cl. 360/97.01

(57) ABSTRACT

A head actuator includes first and second yoke members. An elastic adhesive member is coupled to the second yoke member. A weight is coupled to the elastic adhesive member. The displacement of a coil in the head actuator causes a carriage to swing. The displacement of the coil generates a reaction. Such a reaction causes vibrations in the first yoke member and the second yoke member. Simultaneously, the vibrations of the first yoke member and the second yoke member serve to induce the vibrations of the weight. The elastic adhesive member serves to establish a shift in phase between the vibrations in the first and second yoke members and the vibrations of the weight. The vibrations in the opposite directions counteract each other, so that the vibrations are significantly reduced in the upper and lower yoke members.

This is a continuation filed under 35 U.S.C. § 111(a), of International Application No. PCT/JP2005/010513, filed Jun. 8, 2005.

### BACKGROUND OF THE INVENTION

1. Field of the Invention

The present invention relates to a storage medium drive, such as a hard disk drive, including a voice coil motor, for example.

2. Description of the Prior Art:

A head actuator is incorporated in a hard disk drive. A carriage is coupled to a voice coil motor, VCM, in the head actuator. The voice coil motor includes upper and lower yoke members made of a magnetic material. The upper and lower yoke members are coupled to each other. The upper yoke member is received on bosses standing upright from a base. The upper yoke member is screwed to the bosses. A predetermined gap is defined between the lower yoke member and the base.

A voice coil is placed in a space between the upper and lower yoke members. The voice coil is coupled to the carriage. Magnetic flux circulates through the upper and lower yoke members. The voice coil generates magnetic flux in response to the supply of electric current. The magnetic flux of the voice coil acts on the magnetic flux of the upper and lower yoke members to realize the displacement of the voice coil. The displacement of the voice coil causes the swinging movement of the carriage.

Since a predetermined gap is defined between the lower yoke member and the base, the lower yoke member is supported only on the upper yoke member. Screws are only utilized to support the upper yoke member on the base. When the voice coil is driven to move at a high speed, vibrations are inevitably induced in the yoke members as a reaction, for example. The head actuator thus suffers from a deteriorated positioning of a head slider. The induced vibrations cause noises in the yoke members and the base.

### SUMMARY OF THE INVENTION

It is accordingly an object of the present invention to provide a storage medium drive capable of preventing vibrations and noises.

According to the present invention, there is provided a storage medium drive comprising: a support body; a first yoke member coupled to the support body; a second yoke member coupled to the first yoke member, the second yoke member opposed to the support body; an elastic adhesive member coupled to the second yoke member; a weight coupled to the elastic adhesive member; and a coil opposed to at least one of the first and second yoke members, the coil coupled to a head carriage.

The displacement of the coil causes the head carriage to swing at a high speed in the storage medium drive. The coil moves along an imaginary plane. A reaction is applied to the first yoke member and the second yoke member during the displacement of the coil. Such a reaction causes vibrations in the first yoke member and the second yoke member in parallel with the imaginary plane. Simultaneously, the vibrations of the first yoke member and the second yoke member serve to induce the vibrations of the weight in parallel with the imaginary plane. The elastic adhesive member serves to establish a shift in phase between the vibrations in the first and second yoke members and the vibrations of the weight. The vibrations in the opposite directions counteract each other, so that the vibrations are significantly reduced in the upper and lower yoke members. Reduced vibrations lead to prevention of noises. No vibration is transferred to the head carriage through the support body.

The weight may be received in a through hole penetrating through the support body in the storage medium drive. In this case, the addition of the weight will not hinder achievement of a reduced thickness of the storage medium drive. A predetermined gap is intentionally formed between the outer periphery of the weight and the wall surface of the through hole. The gap reliably enables movement of the weight within the through hole. This leads to a reliably prevention of vibrations in the upper yoke member and the lower yoke member. Noises are reliably prevented. Moreover, the weight can be attached to the outward surface of the second yoke member through the through hole from the outside of the support body. Since the weight is in this manner attached to the second yoke member, the weight can be positioned at a designed position on the second yoke member with a high accuracy by utilizing the relative position between the through hole and the second yoke member. The elastic adhesive member may be made of a viscoelastic material in the storage medium drive. The elastic adhesive member exhibits viscoelasticity.

### BRIEF DESCRIPTION OF THE DRAWINGS

The above and other objects, features and advantages of the present invention will become apparent from the following description of the preferred embodiment in conjunction with the accompanying drawings, wherein:

FIG. 1 is a plan view schematically illustrating the inner structure of a hard disk drive as a specific example of a storage medium drive according to the present invention; and

FIG. 2 is a sectional view taken along the line 2-2 in FIG. 1.

### DESCRIPTION OF THE PREFERRED EMBODIMENT

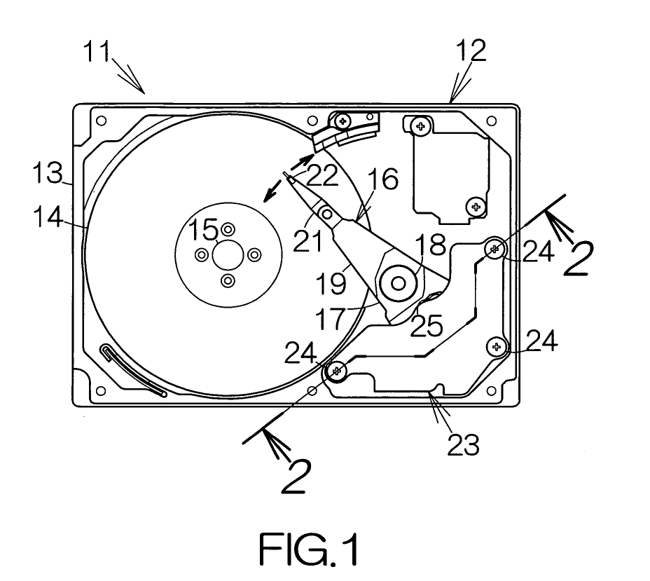

FIG. 1 schematically illustrates a hard disk drive, HDD, 11 as an example of a storage medium drive or a storage device according to the present invention. The hard disk drive 11 includes a box-shaped enclosure 12 including an open box-shaped support body, namely a base 13. The base 13 defines an inner space in the form of a flat parallelepiped, for example. The base 13 may be made of a metallic material such as aluminum, for example. Molding process may be employed to form the base 13.

An enclosure cover, not shown, is coupled to the opening of the base 13. The enclosure cover serves to establish an airtight inner space of the base 13 between the base 13 and the enclosure cover itself. Pressing process may be employed to form the enclosure cover out of a plate material, for example. A metallic plate made of aluminum may be employed as the plate material, for example. Alternatively, the plate material may be a layered material, for example.

At least one magnetic recording disk 14 as a storage medium is placed within the inner space of the base 13. The magnetic recording disk or disks 14 are mounted on the driving shaft of a spindle motor 15. The spindle motor 15 drives the magnetic recording disk or disks 14 at a higher revolution speed such as 5,400 rpm, 7,200 rpm, 10,000 rpm, 15,000 rpm, or the like.

A carriage 16 is also placed within the inner space of the base 13. The carriage 16 includes a carriage block 17. The carriage block 17 is supported on a vertical support shaft 18 for relative rotation. Carriage arms 19 are defined in the carriage block 17. The carriage arms 19 are designed to extend in the horizontal direction from the vertical support shaft 18. The carriage block 17 may be made of aluminum, for example. Extrusion molding process may be employed to form the carriage block 17, for example.

A head suspension 21 is attached to the front or tip end of the carriage arm 19. The head suspension 21 is designed to extend forward from the tip end of the carriage arm 19. A so-called gimbal spring, not shown, is connected to the tip end of the head suspension 21. A flying head slider 22 is fixed on the surface of the gimbal spring. The gimbal spring allows change in the attitude of the flying head slider 22 relative to the head suspension 21.

A so-called magnetic head or electromagnetic transducer, not shown, is mounted on the flying head slider 22. The electromagnetic transducer includes a write element and a read element. The write element may include a thin film magnetic head designed to write magnetic bit data into the magnetic recording disk 14 by utilizing a magnetic field induced at a thin film coil pattern. The read element may include a giant magnetoresistive (GMR) element or a tunnel-junction magnetoresistive (TMR) element designed to discriminate magnetic bit data on the magnetic recording disk 14 by utilizing variation in the electric resistance of a spin valve film or a tunnel-junction film, for example.

When the magnetic recording disk 14 rotates, the flying head slider 22 is allowed to receive airflow generated along the rotating magnetic recording disk 14. The airflow serves to generate positive pressure or a lift and negative pressure on the flying head slider 22. The flying head slider 22 is thus allowed to keep flying above the surface of the magnetic recording disk 14 during the rotation of the magnetic recording disk 14 at a higher stability established by the balance between the urging force of the head suspension 21 and the combination of the lift and the negative pressure.

When the carriage 16 is driven to swing about the vertical support shaft 18 during the flight of the flying head slider 22, the flying head slider 22 is allowed to move along the radial direction of the magnetic recording disk 14. This radial movement allows the electromagnetic transducer on the flying head slider 22 to cross the data zone between the innermost recording track and the outermost recording track. The electromagnetic transducer on the flying head slider 22 can thus be positioned right above a target recording track on the magnetic recording disk 14.

A power source such as a voice coil motor, VCM, 23 is coupled to the carriage block 17. Three, for example, screw members 24 are utilized to fix the voice coil motor 23 on the base 13. A voice coil 25 is coupled to the carriage block 17. The voice coil 25 is designed to extend in the horizontal direction from the vertical support shaft 18. The voice coil 25 is opposed to permanent magnets of the voice coil motor 23 as described later. When the voice coil 25 generates a magnetic field in response to the supply of electric current, the carriage block 17, namely the carriage 16 is driven to swing. The voice coil motor 23 and the carriage 16 constitute a so-called head actuator.

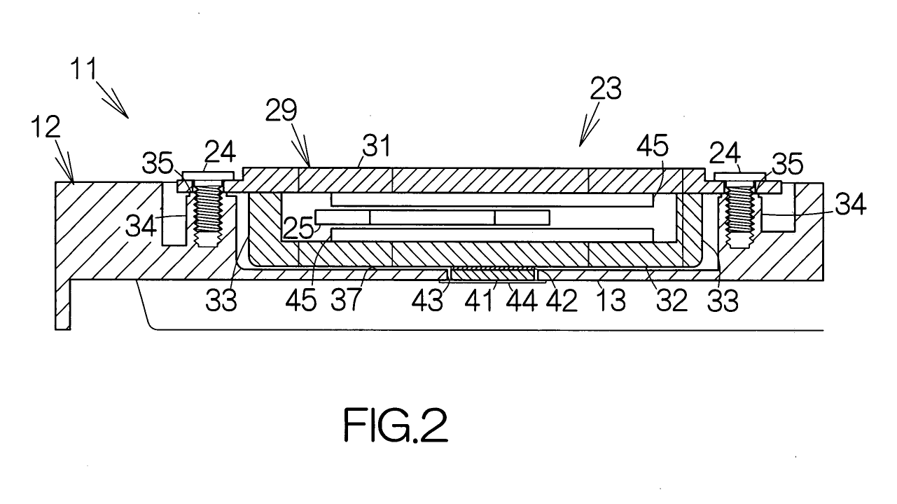

As shown in FIG. 2, the voice coil motor 23 includes a yoke 29. The yoke 29 includes an upper yoke 31 as a first yoke member and a lower yoke 32 as a second yoke member. The lower yoke 32 is coupled to the upper yoke 31. The inward surface of the upper yoke 31 is opposed to the inward surface of the lower yoke 32. A pair of side yokes 33, 33 is formed integral with the lower yoke 32. The side yokes 33 stand upright from the lower yoke 32. The upper ends of the side yokes 33 are coupled to the upper yoke 31. The upper yoke 31, the lower yoke 32 and the side yokes 33 are made of a magnetic material such as iron, for example.

Bosses 34 are defined in the base 13. The bosses 34 stand upright from the upper surface of the bottom plate of the base 13. The bosses 34 may be formed integral with the base 13. First reference surfaces 35 are respectively defined on the top surfaces of the bosses 34. The first reference surfaces 35 are defined within a horizontal plane. The inward surface of the upper yoke 31 is received on the first reference surfaces 35. The aforementioned screws 24 are screwed into the bosses 34, respectively. The upper yoke 31 is in this manner coupled to the first reference surface 35 so that the upper yoke 31 is fixed to the base 13.

The outward surface of the lower yoke 32 is opposed to a second reference surface 37 defined on the upper surface of the bottom plate of the base 13. A predetermined gap is defined between the outward surface of the lower yoke 32 and the second reference surface 37. The second reference surface 37 is differentiated from the first reference surfaces 35. Here, the first reference surfaces 35 are defined at a level higher than that of the second reference surface 37. The second reference surface 37 may be defined in parallel with the first reference surface 35.

A weight 41 is coupled to the outward surface of the lower yoke 32. The weight 41 may be formed in a columnar or disk shape, for example. The weight 41 may be made of a metallic material such as copper or brass, for example. The weight 41 may have a weight or gravity as heavy as possible within a range that can be neglected in the weight of the hard disk drive 11.

An elastic adhesive member 42 is utilized to attach the weight 41 to the lower yoke 32. A double-sided adhesive tape or an elastic adhesive may be employed as the elastic adhesive member 42. The double-sided adhesive tape may include a pair of substrates adhered to the lower yoke 32 and the weight 41, respectively. In this case, a viscoelastic layer is interposed between the substrates. The viscoelastic layer may be made of a viscoelastic material. The elastic adhesive may be made of an adhesive made of a viscoelastic material.

A through hole 43 is formed in the bottom plate of the base 13. The through hole 43 penetrates through the bottom plate from the second reference surface 37. The weight 41 is received in the through hole 43. The through hole 43 may have a circular cross-section, for example. Here, a predetermined gap is formed between the wall surface of the through hole 43 and the outer periphery of the weight 41. The gap enables movement of the weight 41 within the thorough hole 43. A seal member 44 is applied to the opening of the through hole 43 at the outward surface of the bottom plate. The opening of the through hole 43 is airtightly closed in this manner.

The upper yoke 31 and the lower yoke 32 in combination define an inside space. A pair of permanent magnets 45, 45 is placed in the inside space. One permanent magnet 45 is fixed to the inward surface of the upper yoke 31. The other permanent magnet 45 is fixed to the inward surface of the lower yoke 32. The permanent magnets 45, 45 are thus opposed to each other. Magnetic flux from the permanent magnets 45 circulates through the upper yoke 31, the lower yoke 32 and the side yokes 33.

The aforementioned voice coil 25 is placed in the inside space in a space between the permanent magnets 45, 45. The voice coil 25 is simultaneously opposed to the permanent magnet 45 on the upper yoke 31 and the permanent magnet 45 on the lower yoke 32. A gap is formed between the voice coil 25 and the individual permanent magnet 45. A lead wire, not shown, is connected to the voice coil 25. The voice coil 25 generates magnetic flux in response to electric current running through the lead wire.

Now, assume that electric current is supplied to the voice coil 25. The voice coil 25 generates magnetic flux in response to the supply of electric current as described above. The permanent magnets 45 likewise generate magnetic flux. The magnetic flux of the voice coil 25 acts on the magnetic flux of the permanent magnets 45, thereby moving the voice coil 25 within the inside space. The voice coil 25 is driven to swing around the vertical support shaft 18. The carriage arm 19 is allowed to swing in this manner.

A reaction acts on the lower yoke 32 in response to the displacement of the voice coil 25 in the voice coil motor 23. Such a reaction causes vibrations in the upper yoke 31 and the lower yoke 32 in the horizontal direction in parallel with the second reference surface 37, for example. The vibrations of the lower yoke 32 acts on the weight 41 in the horizontal direction in parallel with the second reference surface 37. The viscoelasticity of the elastic adhesive member 42 serves to generate a shift in phase between the vibrations in the upper and lower yokes 31, 32 and the vibrations of the weight 41. The vibrations in the opposite directions counteract each other, so that the vibrations are significantly reduced in the yoke 29. Noises are prevented. No vibration is transferred to the carriage 16 through the screw members 24 and the base 13. Accuracy in positioning the flying head slider 22 can be maintained.

The weight 41 is received in the through hole 43 formed in the lower yoke 32. A predetermined gap is formed between the outer periphery of the weight 41 and the wall surface of the through hole 43. The gap enables the movement of the weight 41 within the through hole 43. The vibrations are reliably reduced in the upper yoke 31 and the lower yoke 32. Noises are reliably prevented. Moreover, since the weight 41 is received in the through hole 43 defined in the bottom plate, the addition of the weight 41 will not hinder achievement of a reduced thickness of the hard disk drive 11.

The base 13 and the yoke 29 are prepared in the production process of the hard disk drive 11. The outward surface of the lower yoke 32 is opposed to the second reference surface 37, while the inward surface of the upper yoke 31 is received on the first reference surface 35. The upper yoke 31 is then coupled to the first reference surfaces 35. The upper yoke 31 is in this manner fixed to the base 13. The elastic adhesive member 42 is beforehand adhered to the weight 41. The weight 41 is applied to the outward surface of the lower yoke 32 through the through hole 43. Since the weight 41 is in this manner attached to the lower yoke 32, the weight 41 is positioned at a designed position on the lower yoke 32 with a high accuracy by utilizing the relative position between the through hole 43 and the lower yoke 32. The seal member 44 is thereafter adhered to the outward surface of the bottom plate of the base 13 for closing the opening of the through hole 43.

What is claimed is:

1. A storage medium drive comprising:
a support body;
a first yoke member coupled to the support body;
a second yoke member coupled to the first yoke member, the second yoke member opposed to the support body;
an elastic adhesive member coupled to the second yoke member;
a weight coupled to the elastic adhesive member; and
a coil opposed to at least one of the first and second yoke members, the coil coupled to a head carriage.

2. The storage medium drive according to claim 1, wherein the weight is received in a through hole penetrating through the support body.

3. The storage medium drive according to claim 1, wherein the elastic adhesive member is made of a viscoelastic material.
